(19) United States
(12) Patent Application Publication
(10) Pub. No.: US 2014/0023802 A1
(43) Pub. Date: Jan. 23, 2014

(54) MULTI-SHEET GLAZING UNIT WITH FLEXIBLY MOUNTED SUSPENDED FILMS AND MANUFACTURING METHODS THEREFOR

(71) Applicant: Yonatan Z. Margalit, Lawrence, NY (US)

(72) Inventor: Yonatan Z. Margalit, Lawrence, NY (US)

(21) Appl. No.: 13/979,839

(22) PCT Filed: Jan. 13, 2012
(86) PCT No.: PCT/US12/21192

§ 371 Date: Oct. 4, 2013

Related U.S. Application Data
(60) Provisional application No. 61/432,750, filed on Jan. 14, 2011.

(51) Int. Cl. E06B 3/663

(52) U.S. Cl. CPC E06B 3/66342
USPC 428/34; 29/428

(57) ABSTRACT

A multi-sheet glazing unit with flexibly mounted suspended films and manufacturing methods are described including a spacer, a first plurality of flexible-mounting-components extending from the spacer in a first direction, each of the first plurality of flexible-mounting-components attached to the spacer at a first end of the flexible-mounting component, a second plurality of flexible-mounting-components extending from the spacer in a second direction, each of the second plurality of flexible-mounting-components attached to the spacer at a first end of the flexible-mounting component, a first flexible film attached to a second end of each of the first plurality of flexible-mounting components, a second flexible film attached to a second end of each of the second plurality of flexible-mounting components, and wherein the first film and the second film are substantially parallel to each other.

### FIELD OF THE INVENTION

The invention relates to the field of multi-sheet glazing units having an air gap divided by suspended films, a method of suspending the films and a sequence to construct the suspended film assembly.

### BACKGROUND OF THE INVENTION

Glazing units may include multiple sheets, panes, or lites (e.g., of glass) positioned in a parallel orientation and separated from each other by, for example, spacers. The sheets may be hermetically sealed together around the edges thereof to form an enclosed air or gas space or static air or gas chamber there between. The sealed chamber may be filled with inert gasses (e.g., argon or krypton), dehydrated air or other gasses to insulate or reduce heat transfer across the unit. The sealed chamber may also be partially open to the exterior environment for example by use of a capillary or breather tube. Desiccant material may be used, e.g., typically within spacers, to adsorb moisture that may enter into the sealed unit over time to prevent condensation of moisture on the sheets.

In sealed or partially sealed glazing units, the efficiency of the entire glazing unit is increased by limiting thermal convection and energy transfer within the air space and thereby reducing heat transfer across the unit. An effective method to reduce thermal convection is to divide the air spaces into multiple chambers or spaces so that the volume of air or gas is shared among the added chambers. In order to create these multiple chambers or spaces, and thereby reduce heat/energy transfer across the unit, one can introduce additional glass sheets or suspend film.

An approach using added glass sheets in a glazing unit will make the glass sheets a critical element in the manufacturing process, increase the glazing unit weight and material cost and may multiply the likelihood of seal failures due to the likely increase of separate sealed chambers and their associated edge seals.

An approach using suspended films in a glazing unit could eliminate glass sheets from the process (which has become an important issue due to high performance, soft-coated and low-emissive glass sheets), would not increase the material costs substantially and does not increase the weight of the overall glazing unit. An additional benefit is the decreased rate of failure normally associated with increased edge seals. Suspending film can lower impact on our environment since manufacturing film requires less raw materials and energy, and less built environment (e.g., the industrial complex created to produce goods and supply services) to create, ship to fabricators and end users, than that for glass sheets.

Methods of suspending film in direct connection and in the same phase with glass may be a limiting factor in its acceptance due to manufacturing issues, associated cost structure, quality control of the manufactured glazing unit assembly and other issues.

Methods of using films in connection with glazing units are known in the art, and are described, for example, in U.S. Pat. No. 5,983,593, U.S. Pat. No. 5,237,787 and U.S. Pat. No. 7,571,583.

One method of suspending film or films requires coated and non-coated glass sheets to be a significant part of the critical path manufacturing process, for example as taught by U.S. Pat. No. 5,983,593. In this process film is sandwiched, in a fixed manner, between metal spacers and glass sheets. The combined parts (including film, metal spacer and glass sheets) are placed in an oven. The glass sheets are a significant part of the assembly process. During the prior art manufacturing process involving film, glass sheets must also be included at the same time or in the same phase.

In U.S. Pat. No. 5,237,787 and U.S. Pat. No. 7,571,583, film support frames or “spring frames” are mounted to the glass sheets and films are mounted to the springs. Glass sheets are a significant part of this assembly process as well.

Procurement of coated glass sheets are sourced from specialty glass fabricators which often have difficulty managing lead times, and the coated glass sheets may arrive damaged or may be damaged during the process of glass preparation.

Inventory of glass sheets requires specialty equipment to receive stoche or other sheets of glass and large specialized racks for storage. A large controlled environment may be built since the coatings placed on the glass can be damaged by moisture and other airborne contaminants.

Processing of glass sheets, especially glass sheets with a high performance, soft low-emissive coating is a laborious process and requires specialized equipment. One critical step in preparing coated glass sheets is to properly remove coatings at the edge of the glass sheet (e.g. “edge deletion”) so that the edge seals achieve proper adhesive properties to the solid glass substrate below the coating. Glass sheets with high performance soft low emissive coatings also require special equipment to clean the surface in preparation for glazing unit assembly. When heat treated or tempered glass sheets are required, the glass sheets should first be tempered and then the high performance low emissive coatings applied. High performance, soft low-emissive coatings must be handled by certified fabricators and each coating has its own unique issues that must be carefully considered. Manufacturers that apply the high performance, soft low-emissive coatings on glass sheets require that a fabricating facility commit to a stringent approval process prior to them being handled.

Furthermore, a cost estimate for the machines required for even a modest facility to fabricate glazing units, exclusive of the film suspension, easily exceeds one million dollars without taking into account the manufacturing space.

### SUMMARY

One embodiment of the present invention may eliminate glass sheets from the manufacturing process windows having multiple interior categories or eliminate glass sheets from the first phase of the manufacturing process.

Another embodiment may eliminate the critical nature of coated glass sheets in the process of suspending film. Another embodiment may allow coated glass sheet placement at the end of the glazing unit process, or in a second phase or later phase of the process.

Another embodiment may eliminate the high performance, soft low-emissive coated glass sheet from the process. It may be more efficient to divide the manufacturing process between, for example, assembly of a frame with internal suspension and assembly of glass sheets onto that frame, since each process may involve different parties with different requirements, overhead cost basis, regulations, insurance, and other costs.

In certain embodiments of the present invention suspended film assembly factories, or “manufacturing pods”, that assemble suspended film assemblies may be deployed adjacent to, or in, factories that currently assemble glazing units. Embodiments may eliminate costs of the machines required for facilities to fabricate glazing units.

Another embodiment may reduce the procurement, inventory and processing of materials when compared to methods using glass sheets. The processes required to suspend film in accordance with certain embodiments of the proposed invention may be modest and can in fact be done primarily by hand and with a minimum requirement for manufacturing equipment such that specialized equipment to handle heavy objects may be utterly eliminated.

Embodiments may incorporate a novel use of a film-support-frame whereby flexible-mounting-components (e.g. springs) are placed in an alternating staggered direction thus supporting multiple films on a single film-support-frame. In certain embodiments of the present invention each flexible-mounting-component may cross one or more other flexible-mounting-components in a plane view in order to place an additional film in an area where just one film would otherwise fit, in a more compact area. Staggering the flexible-mounting-components. (e.g. springs) may allow the components to fit in a more compact area.

In certain embodiments of the present invention the film-support-frame can be used as many times as is practical within a particular glazing unit creating a glazing unit with multiple chambers. The more compact the area is between each film, the more practical it becomes to add more than one film-support-frame, multiple layers of film and thereby create more spaces. Certain embodiments of the present invention may eliminate glass sheets from the process of suspending film.

In certain embodiments of the present invention, a glazing unit may include a spacer or support frame, a first plurality of flexible-mounting-components (e.g. springs) extending from the spacer in a first direction, each of the first plurality of flexible-mounting components attached to the spacer at a first end of the flexible-mounting component, a second plurality of flexible-mounting-components extending from the spacer in a second direction, each of the second plurality of flexible-mounting-components attached to the spacer at a first end of the flexible-mounting component, a first flexible film or flexible sheet attached to a second end of each of the first plurality of flexible-mounting components, and a second flexible film or flexible sheet attached to a second end of each of the second plurality of flexible-mounting components, wherein the first film or sheet and the second film or sheet are substantially parallel to each other.

In one embodiment of the invention, the glazing unit may include two glass sheets mounted to the spacer creating a space enclosing the first and second flexible films.

In one embodiment of the invention, a glazing unit may further include a plurality of spacers, each having a plurality of flexible mounting components extending therefrom. Each of the flexible mounting components may be attached to one of the first flexible film and the second flexible film, and a plurality of glass sheets may be mounted to the spacers creating a space enclosing the first and second flexible films.

In one embodiment of the invention, the first direction of the first plurality of flexible-mounting components, and the second direction of the second plurality of flexible-mounting components may be generally opposite to one another. In one embodiment of the invention, the plurality of flexible-mounting-components may extend in a direction towards the attachment point of one of the other plurality of flexible-mounting-components. In another embodiment of the invention, each of the first plurality of flexible-mounting-components may extend in an opposing direction away from the direction in which the second plurality of flexible mounting components extends.

In one embodiment, the distance between the first flexible film and the second flexible film may be substantially the length of the flexible-mounting-components. In another embodiment of the invention, the distance between the first flexible film and the second flexible film may be at least the length of two of the flexible-mounting-components.

In certain embodiments, a glazing unit may include a substructure, at least one support frame attached to the substructure, each support frame having a plurality of channels or grooves, a first set of stretchable mounting units each having an attachment end attached to one of the plurality of grooves at the attachment end and extending from a groove in a first direction, a second set of stretchable mounting units each having an attachment end attached to one of the plurality of grooves at the attachment end and extending from the groove in a second direction, a first flexible sheet attached to the first set of stretchable mounting units opposite the attachment end of each of the first set stretchable mounting units, a second flexible sheet attached to the second set of stretchable mounting units opposite the attachment end of each of the second set stretchable mounting units, wherein the first sheet and second sheet are substantially parallel to each other.

In one embodiment, the glazing unit may include two glass sheets mounted to the substructure creating a space enclosing the first and second flexible sheets.

In one embodiment, the first direction of the first set of stretchable mounting units, and the second direction of the second set of stretchable mounting units may be generally opposite to one another. In one embodiment of the invention the first direction may extend towards the attachment end of the second set of stretchable mounting units, and the second direction may extend towards the attachment end of the first set of stretchable mounting units. In another embodiment of the invention, the first direction may extend in an opposing direction away from the attachment end of the second set of stretchable mounting units, and the second direction may extend in an opposing direction away from the attachment end of the first set of stretchable mounting units.

In one embodiment the distance between the first flexible sheet and the second flexible sheet may be substantially the length of the stretchable mounting units. In another embodiment of the invention, the distance between the first flexible sheet and the second flexible sheet may be at least the length of two stretchable mounting units.

In one embodiment, a glazing unit may include a plurality of substructures, each substructure having a support frame attached to the substructure, each support frame having a plurality of grooves and a plurality of stretchable mounting units attached to one of the plurality of grooves, and two glass sheets mounted to the substructure creating a space enclosing the first and second flexible sheets.

In some embodiments, a method of manufacturing a glazing unit may include in a first phase, or time period, attaching to a spacer, or other piece, a first plurality, or set, of flexible-mounting-components extending from the spacer in a first direction, each of the first plurality, or set, of flexible-mounting-components attached to the spacer at a first end of the flexible-mounting component, attaching to the spacer, or other piece, a second plurality, or set, of flexible-mounting-components extending from the spacer in a second direction, each of the second plurality, or set, of flexible-mounting-components attached to the spacer at a first end of the flexible-mounting-components, attaching a first flexible sheet or film to a second end of each of the first plurality, or set, of flexible-mounting components, and attaching a second sheet or flexible film to a second end of each of the second plurality, or set, of flexible-mounting components. In a second phase, or time period, glass sheets (e.g. two or more) may be attached to the spacer to create a space enclosing the flexible sheets or films.

In one embodiment of the invention, attaching the flexible-mounting-components may result in an alternating arrangement of the first and second plurality of flexible-mounting-components such that adjacent flexible-mounting-components may extend in generally opposite directions.

In one embodiment, the first and second plurality of flexible-mounting-components may be attached such that the first and second directions may be generally opposite to one another.

In one embodiment, the flexible-mounting-components may be attached such that each of the plurality of flexible-mounting-components may extend in a direction towards the attachment point of one of the other plurality of flexible-mounting-components. In another embodiment of the invention, the flexible-mounting-components may be attached such that each of the plurality of flexible-mounting-components may extend in an opposing direction away from the attachment point of one of the other plurality of flexible-mounting-components.

In one embodiment a layer of stainless steel may be applied to the spacer, or film-support-frame.

### BRIEF DESCRIPTION OF THE DRAWINGS

The principles and operation of the system, apparatus, and method according to embodiments of the present invention may be better understood with reference to the drawings, and the following description, it being understood that these drawings are given for illustrative purposes only and are not meant to be limiting.

FIG. 1 is a cross-sectional illustration of a film-support-frame according to an embodiment of the invention;

FIG. 2 is a cross-sectional illustration of the film-support-frame of FIG. 1 including the flexible-mounting-component, or stretchable mounting unit, and flexible film or sheet according to an embodiment of the invention;

FIG. 3 is a cross-sectional illustration of the film-support-frame of FIG. 1 with the flexible-mounting-components, or stretchable mounting unit, and flexible film or sheet in an opposing direction from the flexible-mounting-component and flexible film shown in FIG. 2 according to an embodiment of the invention;

FIG. 4 is a cross-sectional illustration of the film-support-frame of FIG. 1 with two flexible-mounting-components, or stretchable mounting units, facing opposing directions, which allow for the supporting of two flexible films or sheets according to an embodiment of the invention;

FIG. 4A is an illustration of a plane view of a film-support-frame with a plurality of flexible-mounting-components, or stretchable mounting units, and flexible films or sheets according to an embodiment of the present invention;

FIG. 4B is a cross-sectional illustration of a flexible-mounting-component, or stretchable mounting unit, including dotted reference lines according to an embodiment of the invention;

FIG. 4C is a cross-sectional illustration of a film-support-frame with two flexible-mounting-components, or stretchable mounting units, extending in opposing directions and two flexible films or sheets according to an embodiment of the invention;

FIG. 5 is a cross-sectional illustration of the film-support-frame, flexible-mounting-components, and flexible films of FIGS. 1-4, respectively, shown mounted to a material substructure, which may include a desiccant, according to an embodiment of the invention;

FIG. 6 is a cross-section illustration of a completed sub-assembly including a film-support-frame, flexible-mounting-components, flexible films or sheets, a substructure, desiccant, and glass mounting parts according to an embodiment of the invention;

FIG. 7 is a cross-sectional illustration of the completed sub-assembly of FIG. 6 including two glass sheets according to an embodiment of the invention;

FIG. 8 is a cross-sectional illustration of a glazing unit including two film-support-frames according to an embodiment of the invention;

FIG. 9 is a cross-sectional illustration of an alternate film-support-frame including a flexible-mounting-component, or stretchable mounting unit, according to an embodiment of the invention;

FIG. 10 is a cross-sectional illustration of the film-support-frame of FIG. 9 including a flexible film or sheet according to an embodiment of the invention;

FIG. 10A is a cross-sectional illustration of another alternate film-support-frame using a thermally efficient material according to an embodiment of the invention;

FIG. 11 is a cross-sectional illustration of a completed sub-assembly including two film-support-frames, two flexible-mounting-components, or stretchable mounting units, two flexible films or sheets, a substructure, and a desiccant according to an embodiment of the invention;

FIG. 12 is a cross-sectional illustration of the completed sub-assembly of FIG. 11 including two glass sheets according to an embodiment of the invention;

FIG. 13 is a cross-sectional illustration of another alternate film-support-frame with a glass sheet located in the center area according to an embodiment of the invention;

FIG. 14 is a cross-sectional illustration depicting embodiments wherein the various film-support-frames may be manufactured from a light gauge stainless steel material according to an embodiment of the invention;

FIG. 15 is a flow chart illustrating a method of manufacturing a glazing unit according to an embodiment of the invention; and

FIG. 16 is an illustration of a four-sided completed glazing unit, including a magnified view of a corner of the unit.

For simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate correspondence or analogous elements throughout the serial views.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that a glazing unit, as it is referred to herein, may include any fenestration, window, door, curtain wall, skylight, or structure having two or more spaced sheets, panes, or lites, typically designed to permit the passage of light.

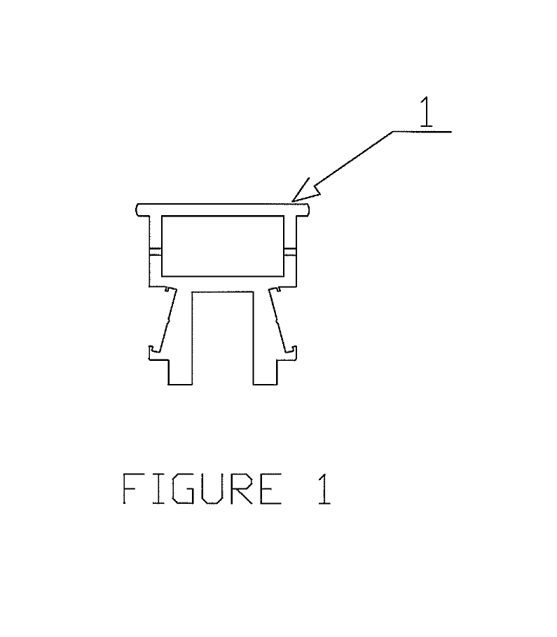

Reference is made to FIG. 1, which is a cross-sectional illustration of a film-support-frame, or spacer, 1 according to one embodiment of the invention. Film-support-frame 1 may be made out of any suitable and durable material, such as, for example, a metal or hard plastic material, although it is noted that film-support-frame 1 does not need to be hardened or stiff, but may be softer (e.g. flexible) such that it is able to flex or contort to a desired shape or conformation. In general, film-support-frame 1 may form a framework to which other components may be attached and may be manufactured to have different shapes such as, for example, the shapes of film-support-frames shown in FIGS. 1, 4, 9, 10A, and 13.

In certain embodiments of the invention, film-support-frame 1 may be a device other than a frame, such as, for example a spacer.

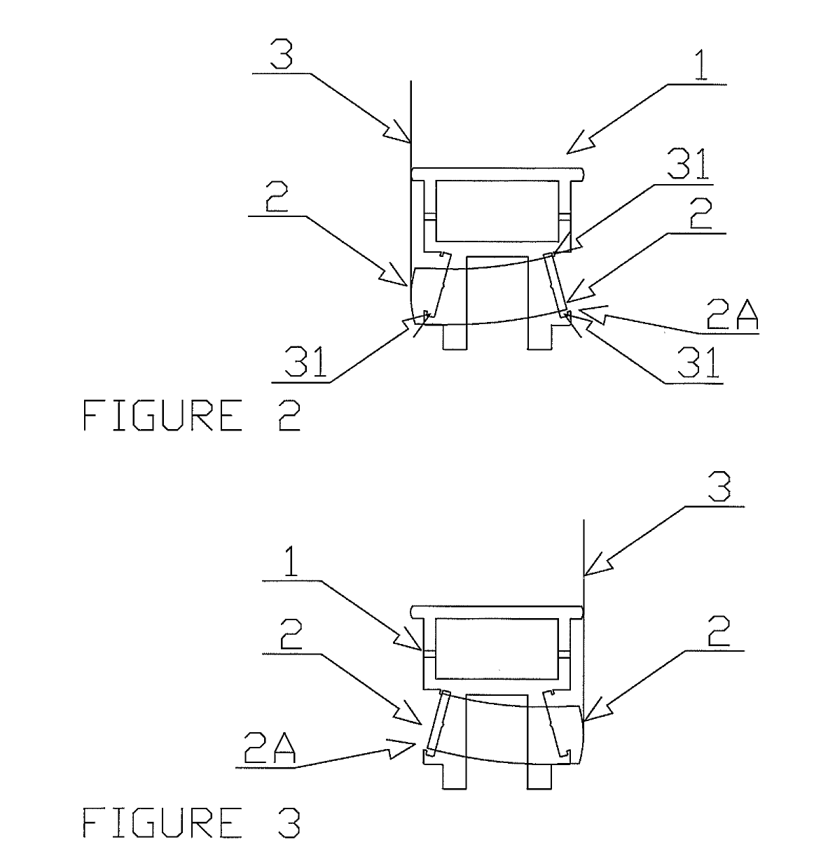

Film-support-frame 1 may include one or more channels or grooves 31 (FIG. 2) for attaching, for example, one or more flexible-mounting-components, or stretchable mounting units (e.g. springs), 2 (FIG. 2).

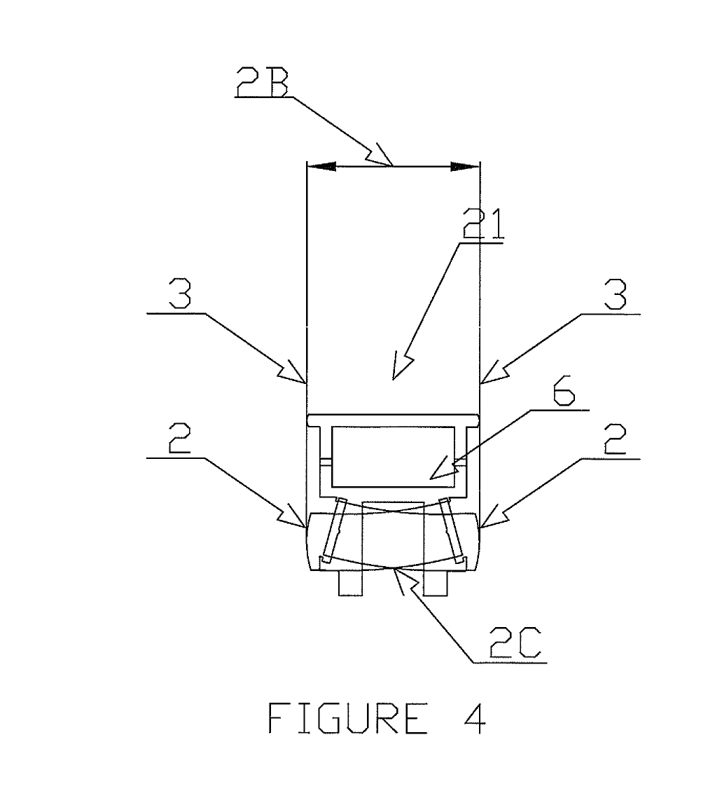

Reference is made to FIGS. 2 and 3, which are cross-sectional illustrations of the film-support-frame, or spacer, 1 of FIG. 1, including the flexible-mounting-component 2 and flexible film, or sheet, 3 according to an embodiment of the invention. The flexible-mounting-component 2 and flexible film 3 are shown in FIG. 3 in an opposing direction or orientation from that of flexible-mounting component 2 and flexible film 3 shown in FIG. 2. In certain embodiments of the invention film-support-frame 1, and the alternate frames as depicted herein, may when glass is mounted on it be a glazing unit. In certain embodiments of the invention insertion of flexible-mounting-component 2 into film-support-frame 1, as shown at location 2A, is easily achieved by hand and/or machine. The grooves 31 may be easily accessed by hand and it may be simple to verify the correct placement of the flexible-mounting-component 2. In certain embodiments of the invention, the grooves 31 act to permanently secure flexible-mounting-component 2 to film-support-frame 1, although it is noted that methods or structures other than grooves 31, may be used to secure flexible-mounting-component, or stretchable mounting unit, 2 to film-support frame 1.

In certain embodiments of the invention, flexible-mounting-component 2 may be straight when not loaded with, or attached to, flexible film or sheet 3. For example, in FIGS. 2 and 3 the flexible-mounting-components 2 are shown as being bent or stretched as film or sheet 3 pulls on or tensions flexible-mounting-component 2. According to embodiments of the present invention, each flexible-mounting-component 2 has a defined length with respect to a first end and second end thereof. However, it is noted that the length of flexible-mounting-component 2 may change after being loaded with flexible film 3 due to being bent or stretched.

In one embodiment of the present invention flexible-mounting-component 2 is a spring, stretchable mounting unit, or other flexible member having at a first end or base (e.g. the location where flexible-mounting-component 2 snaps in to groove 31) a larger diameter, an out-turned wire or coil, or a fitting piece. For example, in one embodiment flexible-mounting-component 2 may taper outward from a second end to the first end of flexible-mounting-component 2. In other embodiments, flexible-mounting-component 2 may have a cap or end piece at a first end or base for attaching to groove 31. In certain embodiments of the invention, compressing part of the flexible-mounting-component 2 may reduce its diameter, allowing it to be fit in to groove 31. When released the base, or end, may snap into groove 31.

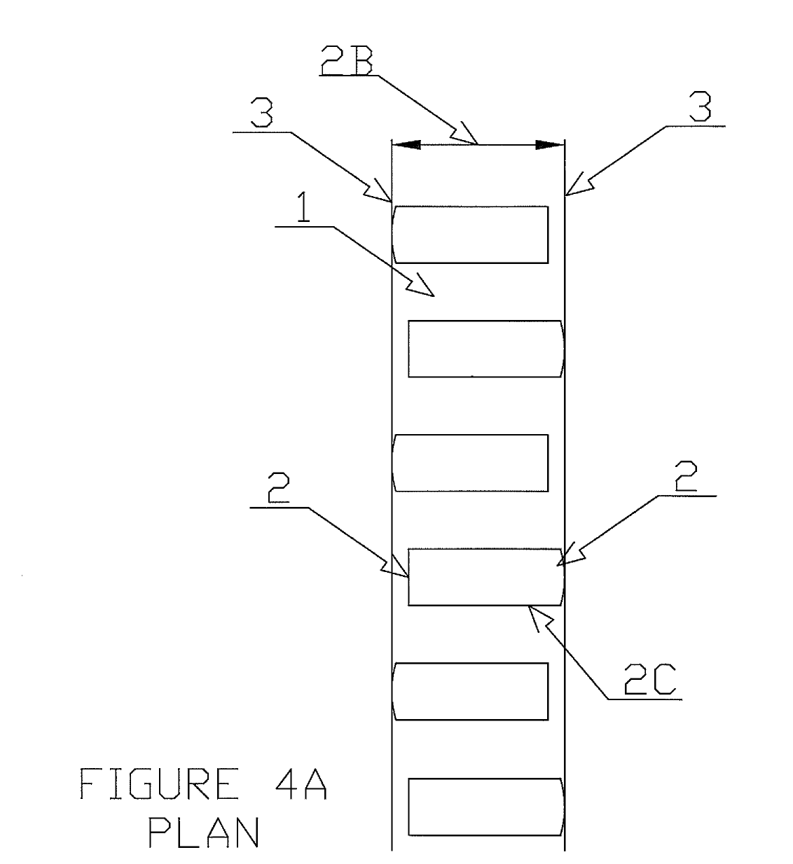

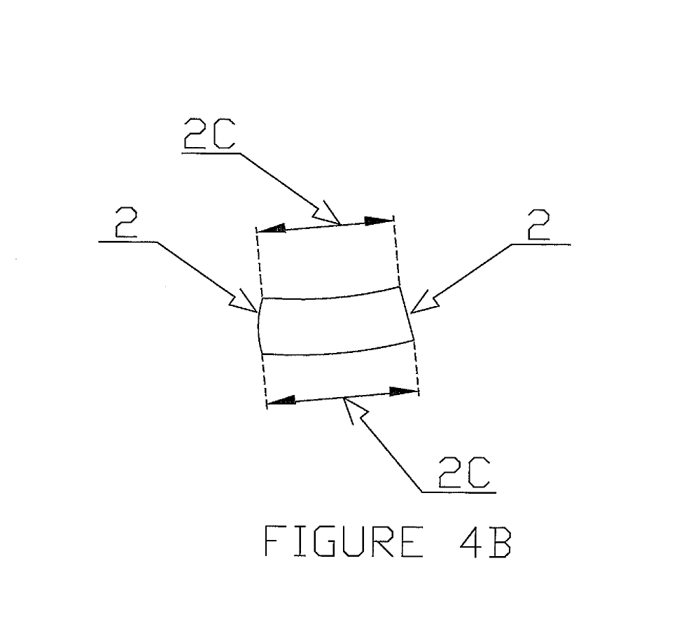

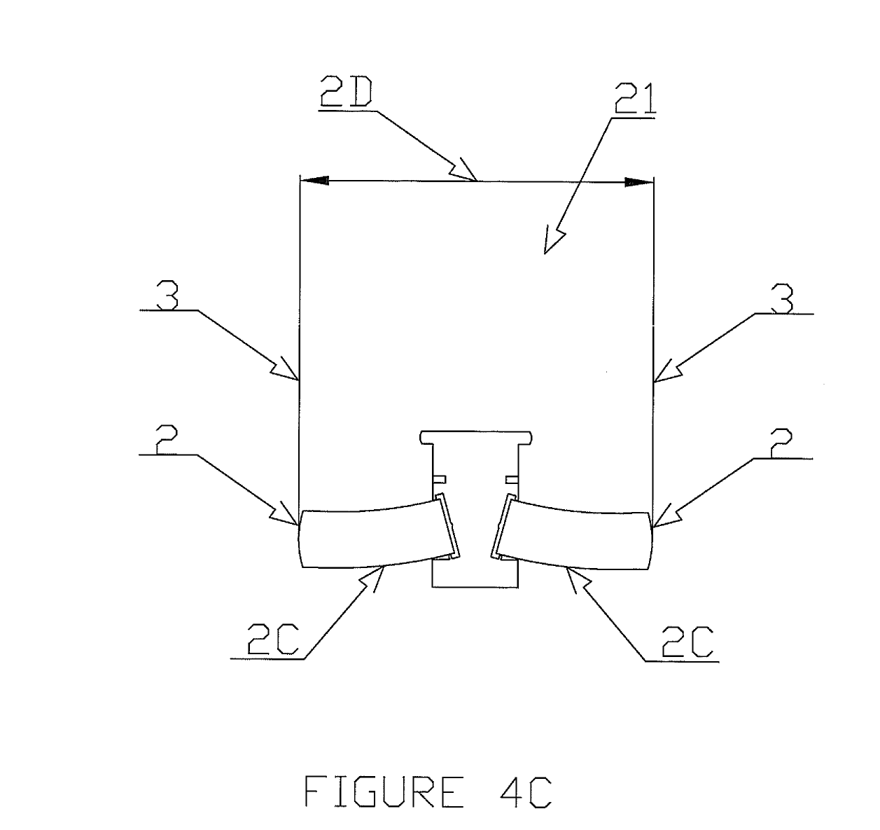

In certain embodiments, flexible-mounting-component 2 may include a first end and a second end. In one embodiment, flexible-mounting-component 2 may be attached to the spacer or film-support-frame 1 at a first end thereof, and a flexible film 3 may be attached to a second end thereof. In one embodiment the first flexible-mounting-component 2 may extend in a direction towards the attachment point of the second flexible-mounting-component 2. In another embodiment the first flexible-mounting-component 2 may extend in an opposing direction away from the second flexible-mounting-component as in, for example, FIG. 4A.

In certain embodiments first and second flexible films 3 are attached to the first and second flexible-mounting components 2, respectively (e.g. FIG. 4).

In certain embodiments, flexible-mounting-component 2, when not loaded with a flexible film 3, may extend straight, or substantially straight, and may bend as shown in, for example, FIGS. 2 and 3, when film or sheet 3, for example, pulls on or tenses flexible-mounting-component 2.

In certain embodiments, flexible-mounting-components or stretchable mounting units 2 may be devices other than metal or plastic springs such as, but not limited to, flat sheet spring steel, flexible foam tapes, very high bond tapes as manufactured by 3M, piano wire or other similar devices. The above-listed items may act separately or joined together to act as flexible-mounting-components 2. In certain embodiments, flexible-mounting-components 2 may be metal coil springs, sheared coil springs, or piano wire, which when not tensed or bent, have coils which touch or rest on one another, but which when tensed or bent, may have parts of its coils separated. Other structures may be used.

In certain embodiments, flexible-mounting-component 2 has a length from to the first end to the second end of approximately 0.25 to 2 inches, preferably 0.25 to 1.5 inches, and still more preferable 0.25 to 1 inches long. In one embodiment flexible-mounting component 2 has a length of approximately 0.5 inches long, although other lengths are possible depending on the requirements of the glazing unit. Other dimensions may be used.

In certain embodiments, generally a first set of stretchable mounting units 2 are mounted to point or extend in a first direction and a second set of stretchable mounting units 2 are mounted to point or extend in a second direction, the first and second direction being opposite or generally opposite to each other. As depicted in, for example, FIGS. 2 and 3, generally opposite need not be at a 180 degree angle. For example, stretchable mounting units may extend toward each other crossing at a slight (e.g., 10 degree, 20 degree, etc.) angle. Since in one embodiment stretchable mounting units bend, the angle of the directions of the stretchable mounting units may change along the axis of the stretchable mounting units. For example, the angle may be larger at mounting points, and may be zero (near parallel or parallel) at the point of attachment to glass sheets. In addition, when sheet or film 3 is mounted to flexible-mounting-components 2 the directions they extend may change slightly, but the two sets of directions may still be generally opposite. Flexible-mounting-component 2 insertion into film-support-frame 1, as shown at location 2A, may be easily achieved by hand and/or machine. Channels or grooves 31 may be easily accessed by hand and it is simple to verify the correct placement of flexible-mounting-component 2. Grooves 31 act to permanently or fixedly secure flexible-mounting-component 2 to film-support-frame 1. In some embodiments, the attachment need not be permanent. Typically, the attachment is not intended to release or snap out under normal loads.

When described herein, two sets of flexible mounting components extend in directions opposite to each other. In a typical embodiment, flexible mounting components extend in directions opposite to each other in a window frame having, typically, four sides or edges (other numbers of edges may be used), and the two “opposite” directions may be different sets of directions in each of the four or other numbers of edges.

In one embodiment, when seen from the side, spacer 1 has a series of openings or holes, allowing each flexible-mounting-component 2 to extend through. The openings or holes may be staggered to match the pattern of flexible-mounting-component 2 mountings. Holes or openings may be made with for example a special drilling assembly, punch die process, or film-support-frame 1 can be made with the holes or openings part of it as can be accomplished in a molded part or another suitable process.

Reference is now made to FIG. 4, which is a cross-sectional illustration of the film-support-frame of FIG. 1 with two flexible-mounting-components or stretchable mounting units 2 facing opposing directions, which allow for the supporting of two flexible films or sheets 3 according to an embodiment of the invention. In certain embodiments, the two flexible films 3 are spaced apart by the distance of space 2B, and create a distinct space 21, which is nominally the length 2C of flexible-mounting-components 2. In certain embodiments of the invention, film 3 is attached to the tip or end of flexible-mounting-component 2. Films 3 may be attached to tips or ends of flexible-mounting-component 2 using, for example sonic welding, but other methods, e.g. gluing, very high bond tape (VHB) may also be used. Alternatively, a strip-like, or continuous strip-like, flexible-mounting-component 2 may be used which attaches flexible-mounting-component 2 to flexible film or sheet 3. Each of the two flexible films or sheets is attached or mounted to one of the two sets of flexible-mounting components, and the films or sheets are substantially parallel to each other. Each set of flexible-mounting-components may extend in a direction towards the attachment point of the other set of flexible-mounting-components. In certain embodiments, flexible-mounting-components (e.g. springs) are distributed along all four sides of the glazing unit or window frame. In this embodiment a flexible film mounted to the flexible-mounting-components may be pulled, tensed, or stretched towards all four sides of the glazing unit by the flexible-mounting-components. Other numbers of sides may be used for the glazing unit, and shapes other than a traditional rectangle may be used.

In certain embodiments, the spacing between flexible-mounting-components may vary. In certain embodiments, the spacing between flexible-mounting-components may be approximately 0.25 to 2.0 inches, preferably 0.25 to 1.5 inches, and still more preferable 0.5 to 1.0 inches. In certain embodiments the spacing between flexible-mounting-components may be approximately 0.75 inches. In a typical embodiment, the spacing between flexible-mounting-components may be less at the corners of the glazing unit than in other areas of the glazing unit in order to create more tension on each flexible film (e.g., the flexible-mounting-components may be closer together at the corners).

FIG. 4A is an illustration of a plane view of a film-support-frame 1 with a plurality of flexible-mounting-components or stretchable mounting units 2 and flexible films or sheets 3 according to an embodiment of the present invention. In certain embodiments of the invention, flexible-mounting-components 2 may be staggered so that there is sufficient space to accommodate a series of them in opposing directions, and two films 3 may be suspended from a single film-support-frame 1. While in FIG. 4A the flexible-mounting-components 2 are shown alternating where each successive component faces an opposite direction, other patterns or arrangements may be used. Staggering or alternating flexible-mounting-components 2, or allowing the components to cross over one another, may allow the components to fit in a more compact area. In certain embodiments of the invention, attaching the flexible-mounting-components 2 results in an alternating arrangement such that the directions in which adjacent flexible-mounting-components 2 extend may be generally opposite to one another. Staggering or alternating may include, for example, having a flexible-mounting-component extending in a first direction next to a flexible-mounting-component extending in a second direction next to a flexible-mounting-component extending in the first direction next to a flexible-mounting-component extending in the second direction, etc.

In certain embodiments of the invention a glazing unit may include a single spacer 1, which may include a first plurality of flexible-mounting-components 2 extending from spacer 1 in a first direction. Each of the first plurality of flexible-mounting-components 2 may be attached to spacer 1 at a first end of the flexible-mounting-component 2, with a second plurality of flexible-mounting-components 2 extending from spacer 1 in a second direction, each of the second plurality of flexible-mounting-components 2 attached to spacer 1 at a first end of the flexible-mounting-component 2. A first flexible film 3 may be attached to a second end of each of the first and second plurality of flexible-mounting-components 2, and a second flexible film 3 may be attached to a second end of each of the second plurality of flexible-mounting-components 2, wherein first and second film 3 are substantially parallel to each other. In certain embodiments, a single film-support-frame or spacer 1 may have a plurality of channels or grooves 31 for attaching the first and second plurality of flexible-mounting-components 2. In certain embodiments, the first and second directions are generally opposite to one another, although there may be other arrangements.

Reference is now made to FIG. 4B, which is a cross-sectional illustration of a flexible-mounting-component or stretchable mounting unit 2 according to certain embodiments of the invention. Length 2C of flexible-mounting-component 2 typically dictates spacing between films 3 and could vary depending on length 2C of flexible-mounting-assembly 2. The dotted lines in FIG. 4B are reference lines and indicate the length 2C with respect to the dimensions of the flexible-mounting-component 2.

Reference is now made to FIG. 4C, which is a cross-sectional illustration of a film-support-frame 1 with two flexible-mounting-components or stretchable mounting units 2 extending in opposing directions, and two flexible films or sheets 3 according to an embodiment of the invention. In certain embodiments of the invention the direction of each set of components is extending away from the base of the other set of components. In certain embodiments of the invention the dimension or space 2D between films 3 and the corresponding space 21 is nominally double the length of flexible-mounting-component 2. In other embodiments of the invention the distance between films 3 is at least the length of two of the flexible-mounting-components 2, and additional space may be accommodated for other components of the assembly, such as, for example, film-support-frame 1. The benefits of the spring-support-frame as shown in FIG. 4 are here further explained by comparison.

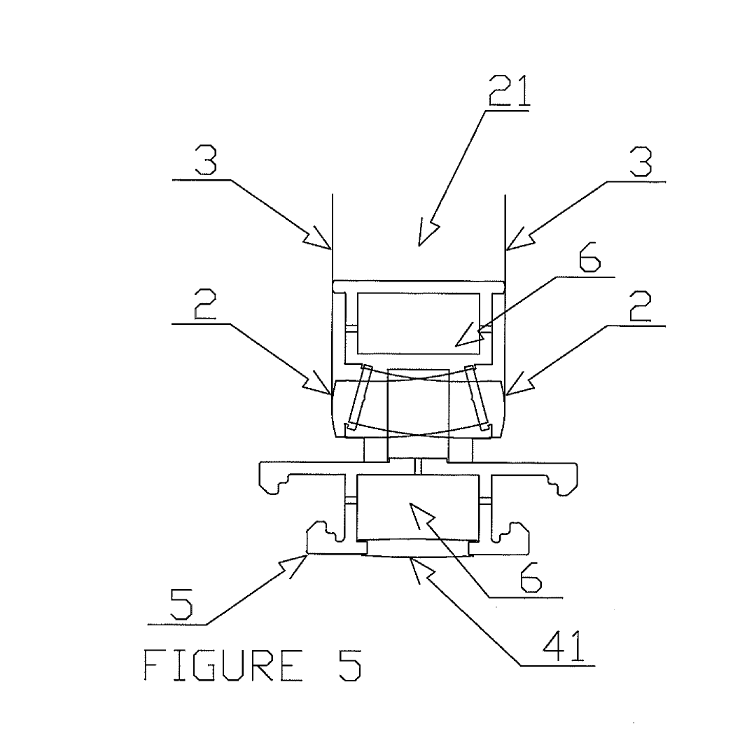

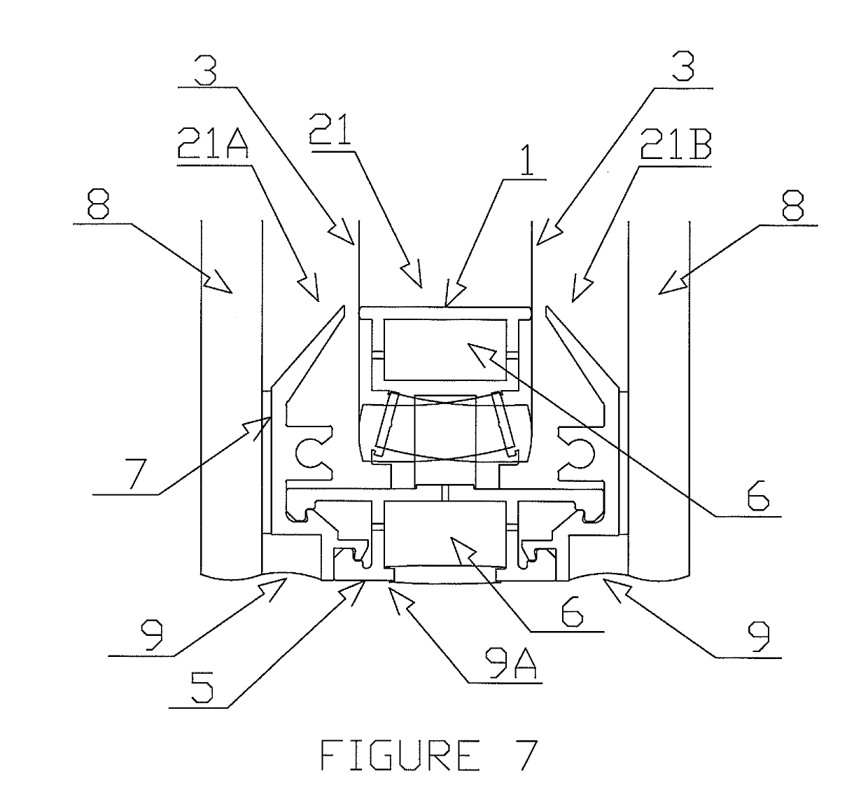

FIG. 5 is a cross-sectional illustration of the film-support-frame 1, flexible-mounting-components 2, and flexible films 3 of, for example, FIGS. 1-4, respectively, shown mounted to material substructure 5, which may include desiccant 6, according to an embodiment of the invention. In certain embodiments, material substructure 5 may be thermally improved in order to, for example, reduce the transfer of heat and or energy between the interior and exterior of the glazing unit. Removable access panel 41 may be used to insert, remove or recharge desiccant 6 as may be required. Removable access panel 41 may be a transparent material to facilitate verification of desiccant 6 placement during manufacturing and to check levels of saturation during its useful life. Desiccant material 6 may be in a single serviceable reservoir and may serve to dehydrate spaces 21, 21A and 21B (FIG. 7). In one embodiment, the added spaces 21, 21A and 21B do not increase the edge seals 9 (see FIG. 7) beyond one directly adjacent to each of the glass sheets, 8. For example, in certain embodiments, added spaces 21, 21A and 21B do not increase the width, or dimensions, of edge seals 9, such that edge seals 9 are smaller and, therefore, less prone to acquiring defects or failing. Additionally or alternatively, in certain embodiments added spaces 21, 21A and 21B do not increase the number of edge seals 9 such that the glazing unit requires fewer edge seals overall. Having fewer edge seals may help to increase the overall quality of the glazing unit as there are fewer seals that may fail or become defective. It is noted that while the benefits of fewer edge seals are discussed herein with respect to FIG. 5, this discussion is relevant to all other discussions related to edge seals throughout the specification, as well as to the process of manufacturing glazing units overall.

In certain embodiments desiccant 6 may be composed of any suitable desiccant such as, for example, silica gel, activated charcoal, calcium sulfate, calcium chloride, montmorilllonite clay, or other suitable desiccants.

In certain embodiments of the invention, material substructure 5 is used to attach other components of the invention such as, for example, one or more film-support-frames 1.

In certain embodiments, a glazing unit includes a substructure 5, at least one support frame 1 attached to substructure 5, each support frame 1 having a plurality of channels or grooves 31, a first set of stretchable mounting units 2 each having an attachment end attached to one of the plurality of grooves 31 at the attachment end and extending from groove 31 in a first direction, a second set of stretchable mounting units 2 each having an attachment end attached to one of the plurality of grooves 31 at the attachment end and extending from groove 31 in a second direction, a first flexible sheet 3 attached to the first set of stretchable mounting units 2 opposite the attachment end of each of the first set of stretchable mounting units 2, a second flexible sheet 3 attached to the second set of stretchable mounting units 2 opposite the attachment end of each of the second set of stretchable mounting units 2, wherein first sheet 3 and second sheet 3 are substantially parallel to each other. In certain embodiments two glass sheets 8 may be mounted to substructure 5 creating a space enclosing first and second sheets 3.

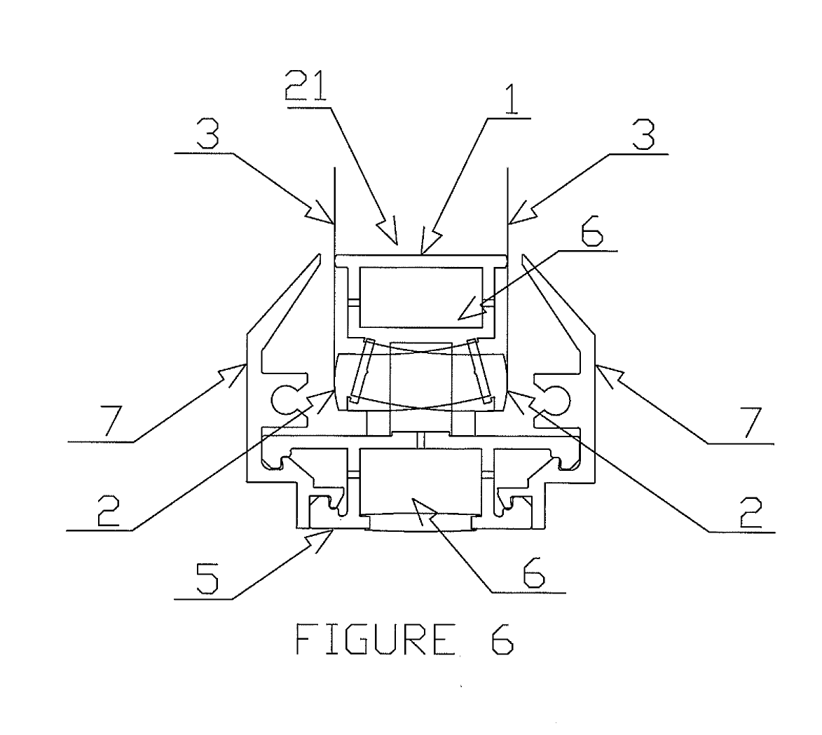

FIG. 6 is a cross-section illustration of a completed sub-assembly including a film-support-frame 1, flexible-mounting-components 2, flexible films or sheets 3, a substructure 5, desiccant 6, and glass mounting parts 7 according to an embodiment of the invention. The assembly as described in FIG. 6 is now ready to receive the exterior glass sheets 8. It should be noted that in certain embodiments of the invention, film-support-frame 1, flexible-mounting-components 2, substructure 5, and glass mounting parts 7 may be made of the same or different material depending on the need and nature of the desired glazing unit. For example, film-support-frame 1, flexible-mounting-components 2, substructure 5, and glass mounting parts 7 each may be made out of a metal or hard plastic material, or a combination of the two. In certain embodiments, film-support-frame 1, flexible-mounting-components 2, substructure 5, and glass mounting parts 7 are made of a material other than metal and are wrapped with a layer of metal, such as, for example, stainless steel.

Reference is now made to FIG. 7, which is a cross-sectional illustration of the completed sub-assembly of FIG. 6 including two glass sheets 8 arranged on each side of the completed sub-assembly according to an embodiment of the invention. Glass sheets 8 may be applied by, for example a glazing unit fabricator as is known in the art. In certain embodiments one or more spaces may be created by glass sheets 8; e.g., in this example spaces 21A and 21B have been created. The next and in some cases final operation in a process according to the present invention may be the application of the edge seal 9 which may include a vapor barrier 9A. This is a completed unit which is ready to be used in a building fenestration assembly.

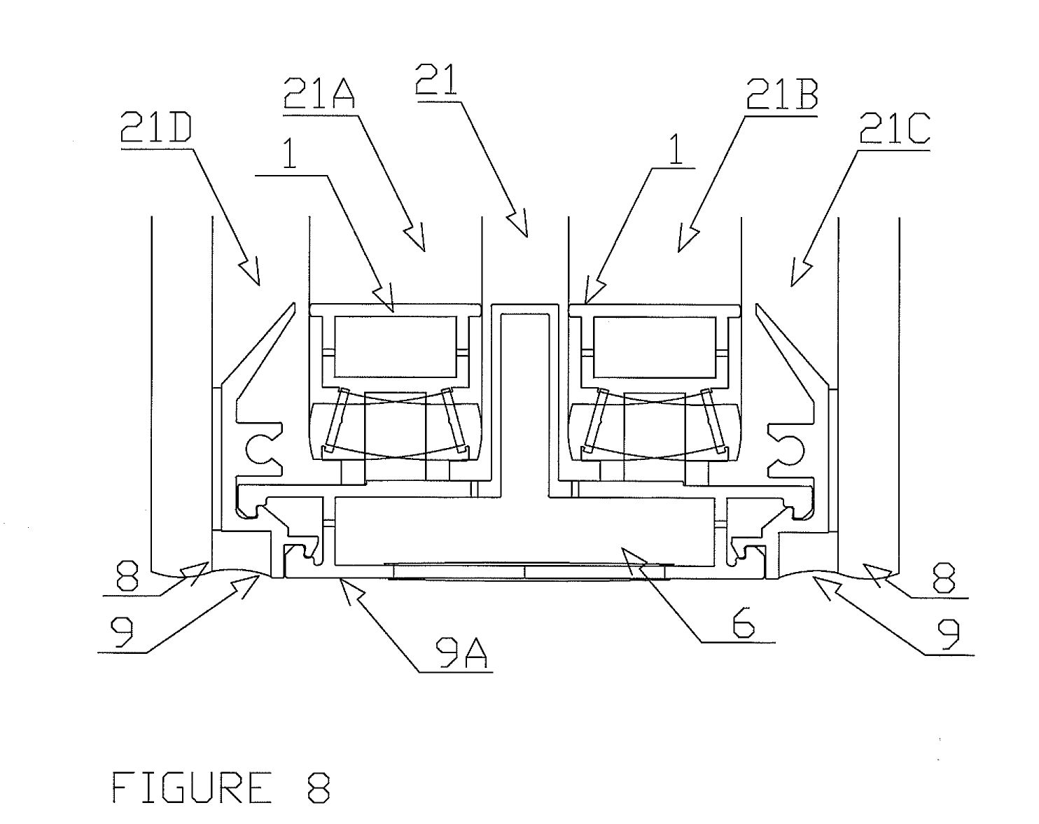

FIG. 8 is a cross-sectional illustration of a glazing unit including two film-support-frames 1 according to an embodiment of the invention. Each film-support-frame 1 as shown in FIG. 8 includes flexible-mounting-components 2 and films or sheets 3 such as shown, for example, in FIG. 4. In certain embodiments two film-support-frames 1 may be used, although a glazing unit of the present invention may have more than two film-support-frames 1, such as, for example, three or more depending on the requirements of the glazing unit and the size of substructure 5. In certain embodiments, air spaces 21, 21A, 21B, 21C and 21D do not increase edge seals 9 beyond one directly adjacent to each of glass sheets 8. Desiccant material 6 may be in a single serviceable reservoir and may serve to dehydrate spaces 21, 21A, 21B, 21C and 21D.

FIG. 9 is a cross-sectional illustration of an alternate film-support-frame 10 including a flexible-mounting-component or stretchable mounting unit 2 according to an embodiment of the invention. In certain embodiments, flexible-mounting-component 2 is attached to alternate film-support-frame 10 in location 2A is a similar manner as attached to film-support-frame 1. In certain embodiments, location 2A is readily accessible by hand and/or machine. The assembly shown in FIG. 9 may suspend one film 3, but it can be joined into a solid frame, such as substructure 5, by using screw bosses 11 to fasten the corners together. Screw boss, corner key, alignment key location 11 may be a method of joining alternate film-support-frame 10 parts into an assembly that can support itself without using a glass sheet to mount and hold film-support-frame. Alternate film-support-frame 10 may also act as the glass mounting bracket 7 as shown in, for example, FIGS. 6 and 7. A glass sheet 8 may ultimately be mounted to alternate film-support-frame or spacer 10, but typically not until the assembly is completed. Alternate film-support-frame 10 may be joined at a corner by use of a metal bending, corner welding process for materials made of stainless steel or other suitable material. Alternate film-support-frame 10 may in some embodiments support only one film 3 but does benefit from the manufacturing process described below.

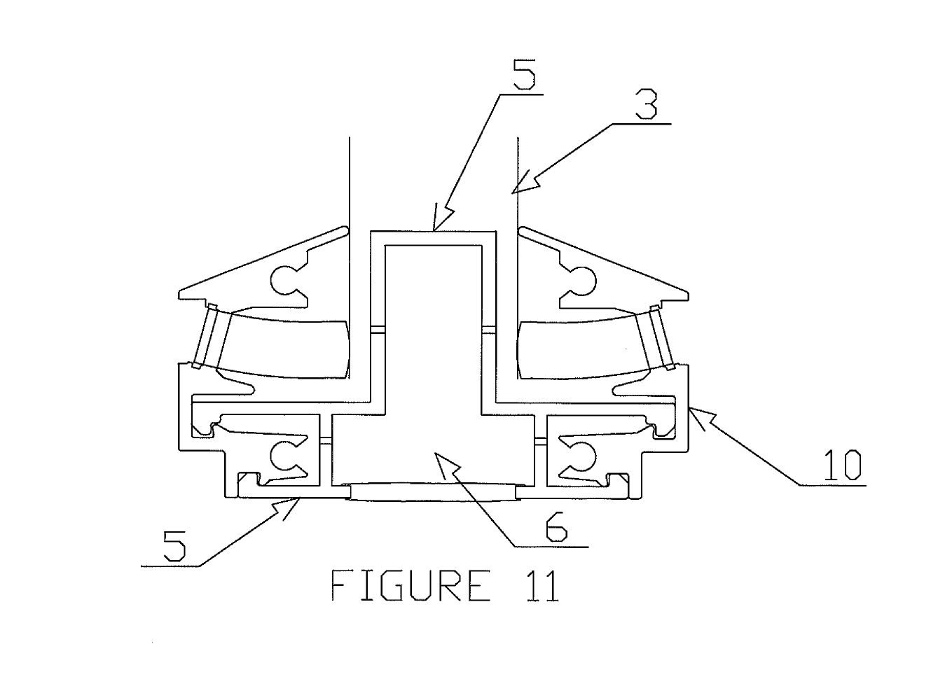

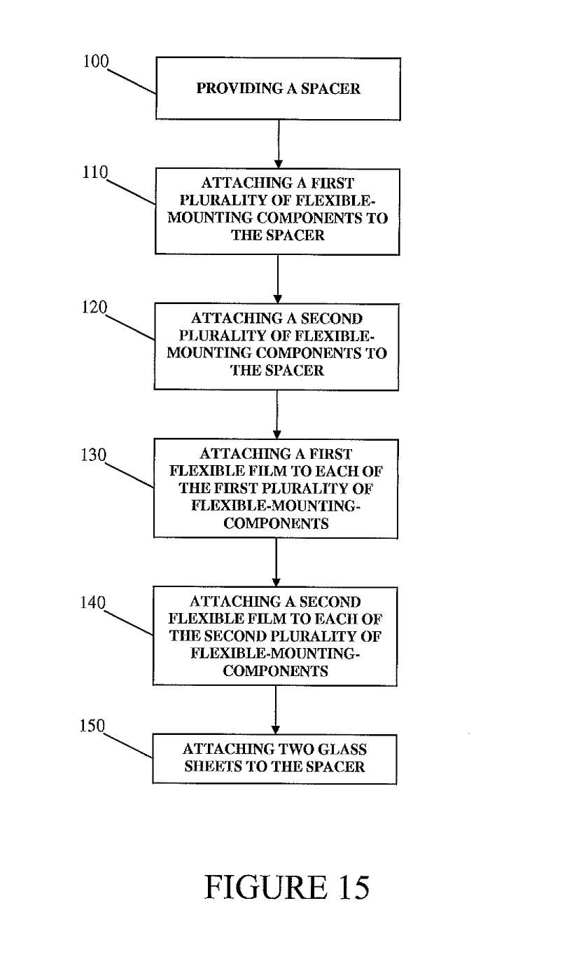

In certain embodiments of the present invention, all of the processes described above may be completed independent of glass sheets 8. For example, FIG. 15 is a flow chart illustrating a method of manufacturing a glazing unit according to an embodiment of the invention. In operation 100, for example, a spacer, or film-support-frame (e.g. film-support-frame 1), is provided, which, according to certain embodiments of the invention, is adapted or configured to accept one or more flexible-mounting-components (e.g. flexible-mounting-component 2). In further operation 110, for example, a first plurality of flexible-mounting-components may be attached to the spacer, and in operation 120, a second plurality of flexible-mounting-components may be attached to the spacer. In another operation 130 a first flexible film (e.g. flexible film or sheet 3) may be attached to each of the first plurality of flexible-mounting-components, and in operation 140 a second flexible film or sheet may be attached to each of the second plurality of flexible-mounting-components. In certain embodiments, completing operations 100-140 produces a completed sub-assembly such as the sub-assemblies illustration in, for example, FIGS. 6 and 11. After the sub-assembly has been completed, two glass sheets (e.g. glass sheets 8) may be attached to the spacer, such as in operation 150, thereby producing a completed glazing unit.

In certain embodiments of the invention operations 100-150 may be followed to manufacture glazing units as depicted in, for example, FIGS. 1-14. However, operations 100-150 are not limited, and may be followed in order to manufacture other glazing units not illustrated by FIGS. 1-14.

In certain embodiments, operations 100-150 may be performed as a single process and may be performed sequentially such as depicted in FIG. 15. In another embodiment of the invention operations 100-150 may not be performed sequentially, and may be performed in a different sequence than what is depicted in FIG. 15. For example, in certain embodiments attaching the first plurality of flexible-mounting-components 110 may be followed sequentially by next attaching the first flexible film to each of the first plurality of flexible-mounting-components 130. In this embodiment, operations 120 and 140 may follow operations 110 and 130. In other embodiments, different sequences of operations 100-150 are possible.

In certain embodiments, operations 100-150 may be performed in different phases of manufacturing. In certain embodiments of the invention, different combinations of operations 100-150, may be combined in different phases of manufacture. For example, in certain embodiments a first, or initial, phase may include operations 100-140, and a second phase may include operation 150. For example, in certain embodiments of the invention a method of manufacturing a glazing unit may include a first phase including attaching to spacer 1 a first plurality of flexible-mounting-components 2 extending from spacer 1 in a first direction. Each of first plurality of flexible-mounting-components 2 may be attached to spacer 1 at a first end of flexible-mounting-component 2. An embodiment may include attaching to spacer 1 a second plurality of flexible-mounting-components 3 extending from spacer 1 in a second direction. Each of second plurality of flexible-mounting-components 3 may be attached to spacer 1 at a first end of flexible-mounting-component 2. The embodiment may include attaching first flexible film 3 to a second end of each of the first plurality of flexible-mounting-components 2, and attaching second flexible film 3 to a second end of the second plurality of flexible-mounting-components 2, and, in a second phase, attaching two glass sheets 8 to spacer 1 to create a space enclosing the first and second flexible films 3. In certain embodiments flexible-mounting-components 2 may be attached in an alternating arrangement of first and second plurality of flexible-mounting-components 2 such that adjacent flexible-mounting-components 2 extend in generally opposite directions. In certain embodiments flexible-mounting-components 2 may be attached such that the first and second directions are generally opposite to one another.

In certain embodiments of the invention, flexible-mounting-components 2 may be attached such that each of the plurality of flexible-mounting-components 2 extends in a direction towards the attachment point of one of the other plurality of flexible-mounting-components 2. In another embodiment of the present invention, flexible-mounting-components 2 may be attached such that each of the plurality of flexible-mounting-components 2 extends in an opposing direction away from the attachment point of one of the other plurality of flexible-mounting-components 2.

The operation of attaching a layer of stainless steel, or other material, to spacer 1 to strengthen it, or to provide for easier construction and assembly, may be used.

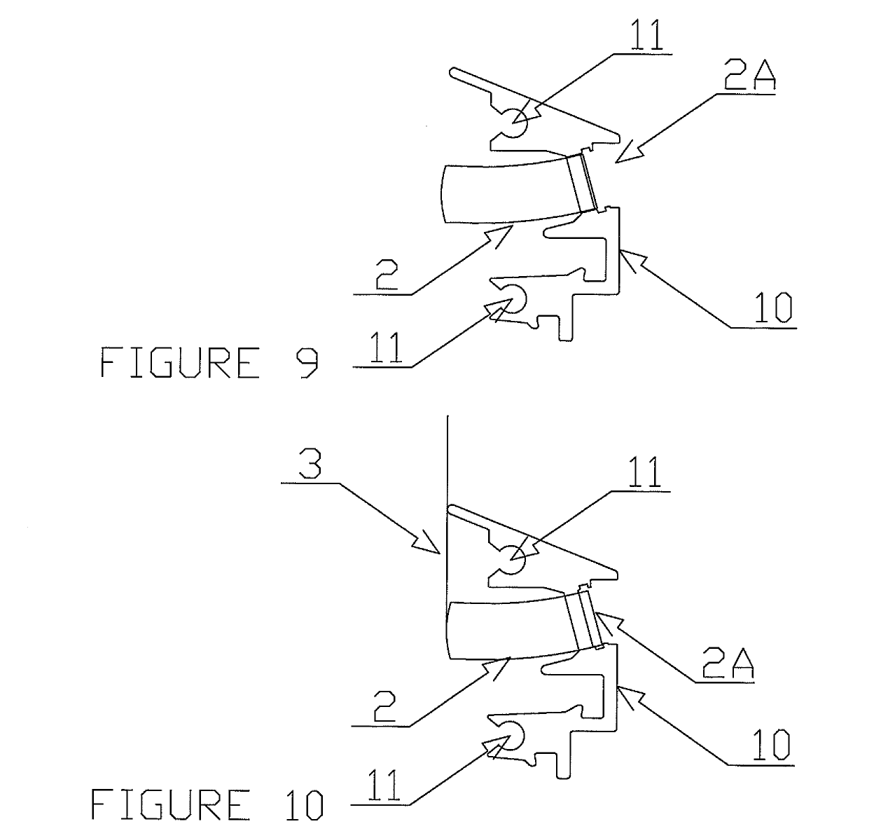

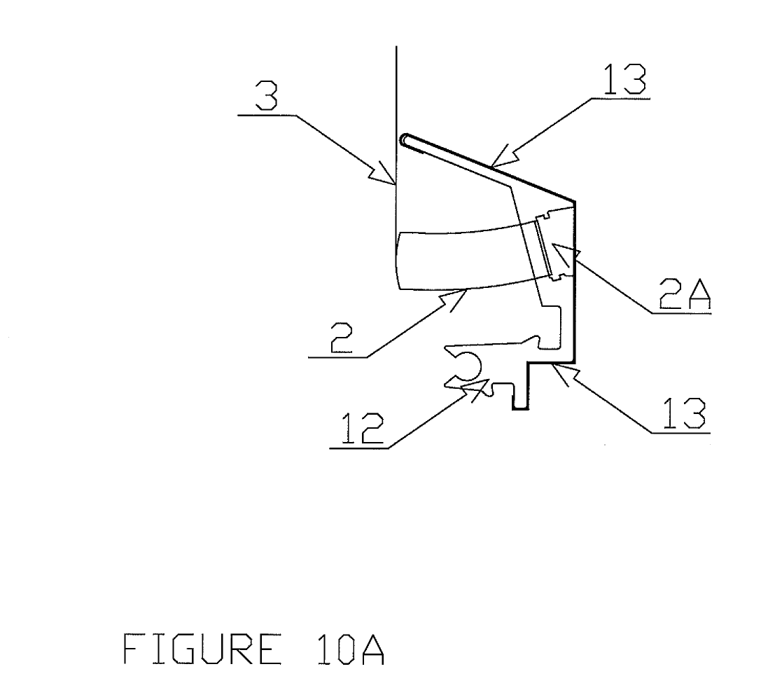

FIG. 10 is a cross-sectional illustration of film-support-frame 10 of FIG. 9 including flexible-mounting-component 2 and flexible film or sheet 3, but without glass sheets, according to an embodiment of the invention. In certain embodiments the assembly as shown in FIG. 10 may then be sent to an adjacent work area or a separate glass sheet facility for final assembly with glass sheets 8. The specialty trade of using film-support-frame 1, flexible-mounting-component 2 and films 3, may be kept separate from glass fabrication, glass cleaning and final placement of glass sheets 8 and the sealing of the glazing unit. In one embodiment of the invention the alternate film-support-frame 10 as shown in, for example, FIGS. 9 and 10, suspends one film 3 but does benefit from the manufacturing process described herein. In certain embodiments of the invention, the processes described herein may be performed independently of including glass sheets 8, such as, for example, separating the processes into two or more phases. It is conceivable, however, that all the processes may be performed in a single phase if needed or required.

FIG. 10A is a cross-sectional illustration of another alternate film-support-frame 12 using a thermally efficient material according to an embodiment of the invention. In certain embodiments, alternate film-support-frame 12 is manufactured using thermally efficient material such as, for example, plastic or other suitable material and is wrapped in a stainless steel material 13. The benefits of incorporating a stainless steel material 13 may include that it is easily shaped, cut, welded at the corners with readily available machines, and could substantially increase the quality of the product. Also the time required to assembly may be greatly reduced. In certain embodiments, the processes described herein may be performed independent of including glass sheets 8.

FIG. 11 is a cross-sectional illustration of a completed sub-assembly including two alternate film-support-frames 10, two flexible-mounting-components or stretchable mounting units 2, two flexible films or sheets 3, a substructure 5 and desiccant 6, without glass sheets installed, according to an embodiment of the invention. In certain embodiments alternate film-support-frames 10, and substructure 5 may be snapped together, although it is noted that other methods of attachment may be used such as, for example, gluing, molding, welding or taping.

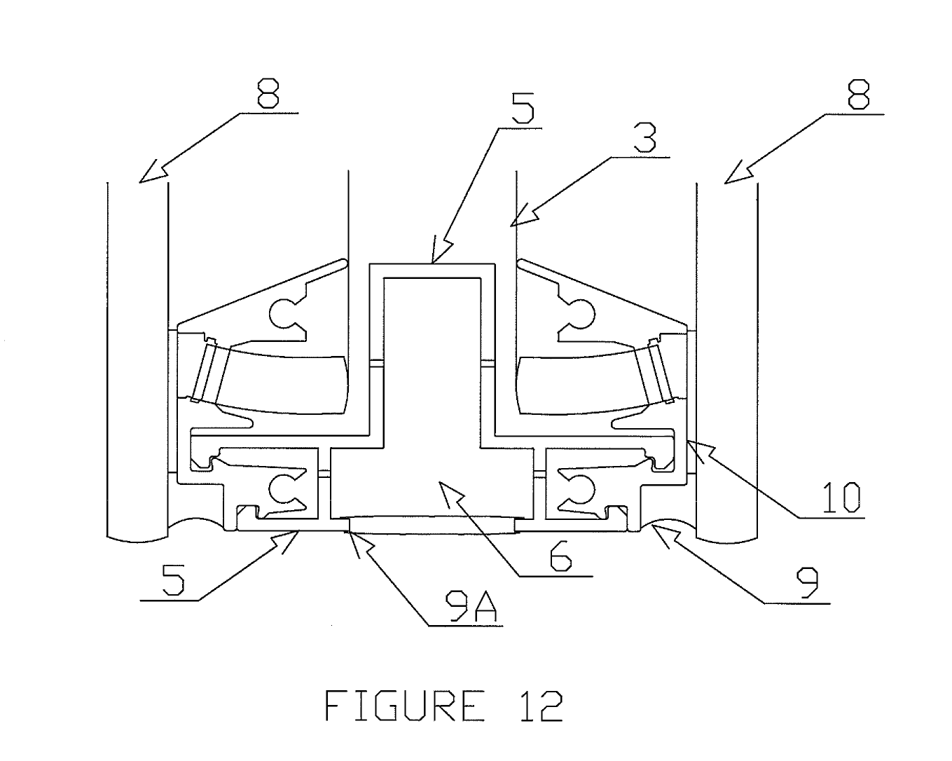

Reference is now made to FIG. 12, which is a cross-sectional illustration of a completed sub-assembly as shown in FIG. 11, including two glass sheets 8 according to an embodiment of the invention.

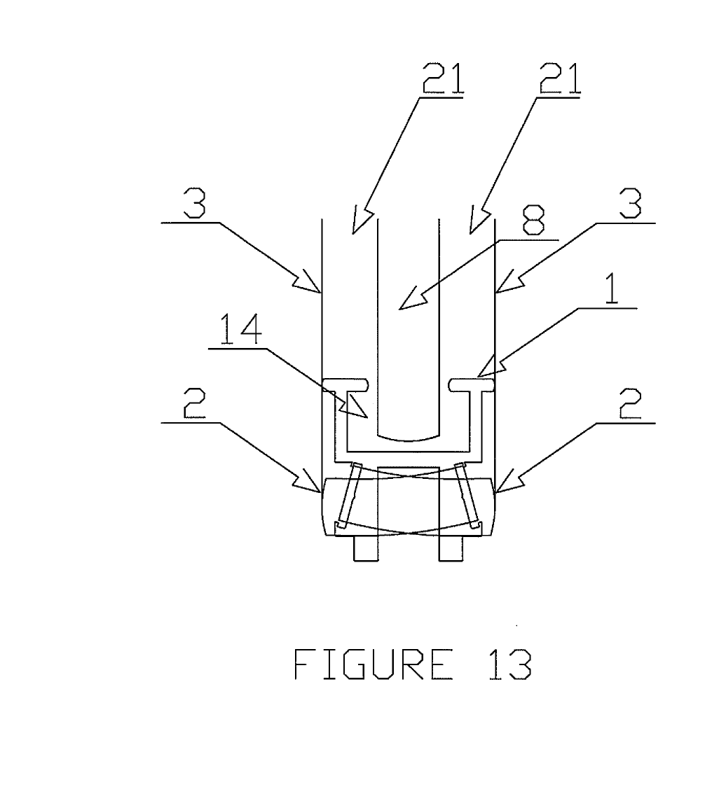

FIG. 13 is a cross-sectional illustration of an alternate film-support-frame 1 with a glass sheet 8 located in the center area 14, according to an embodiment of the invention. In certain embodiments an alternate film-support-frame 1 may have a glass sheet 8 located in a center “U” shaped area 14. An embodiment of this design may deviate in some ways from an optimal manufacturing process, as glass is introduced to the process. In one embodiment, if the glass sheet 8 is not coated with a low emissive material, then the processes of procurement, inventory, processing, and commissioning of a facility is far less complicated. If the glass is clear un-coated glass there are few special processes required since one cannot scratch or otherwise damage a low emissive coating. The type of glass according to this embodiment is typically easy to find, fabricate, wash and otherwise handle. The center glass as described in this embodiment, and as shown in FIG. 13, adds another air space to the glazing unit, thereby aiding in increasing the efficiency of the glazing unit. Ease of placement of flexible-mounting-components 2, may be similar or identical to the processes described elsewhere herein. In certain embodiments, the staggered aspect of flexible-mounting-components 2 may also be similar or identical such that there is sufficient space to accommodate a series of the flexible-mounting-components 2 in opposing directions and thereby supporting multiple films 3.

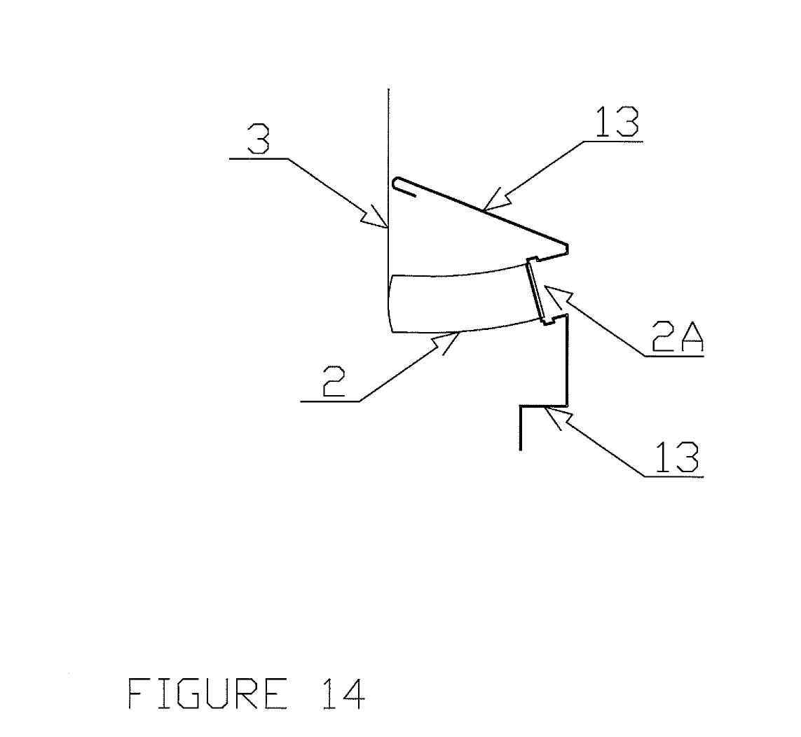

FIG. 14 is a cross-sectional illustration depicting embodiments wherein the various film-support-frames, such as, for example, film-support frames or spacers 1, 10, and 12, may be manufactured from a light gauge stainless steel material 13 according to an embodiment of the invention. The benefits of stainless steel material 13, according to certain embodiments, may be that it is easy to form, join at the corners with “spot welding” and it can all be accomplished with an off-the-shelf (e.g. common) automated machine process. A film-support-frame according to certain embodiments that is manufactured from stainless steel material 13 may have sufficient thermal properties and may be combined with a thermally improved substructure 5 and as described, for example, in FIG. 5.

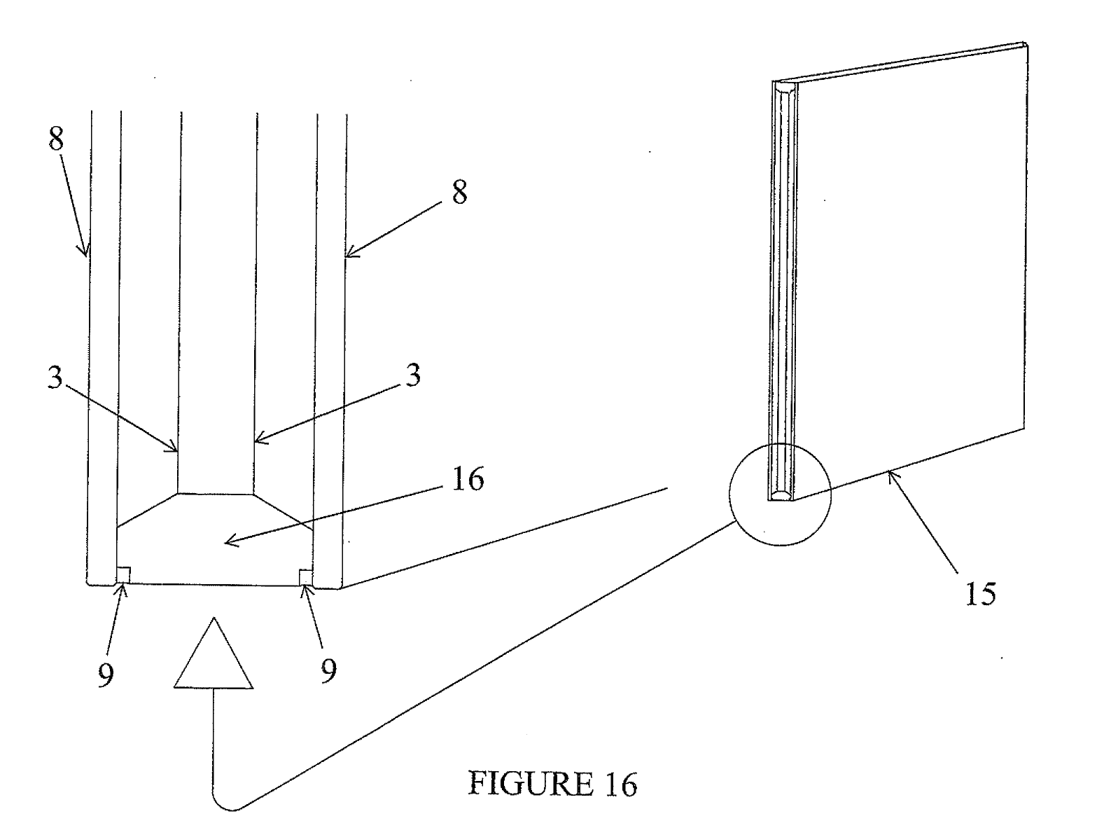

FIG. 16 is an illustration of a four-sided completed glazing unit 15, including a magnified view of a corner of the unit. Glazing units in other embodiments may have other numbers of sides. In some embodiments, completed glazing unit 15 may include a completed sub-assembly 16, flexible films 3, glass sheets 8, and edge seals 9. Completed sub-assembly 16 may include, for example, film-support-frame 1 including grooves 31 (not shown), flexible-mounting-components 2 substructure 5 (not shown), glass mounting parts 7 (not shown), and desiccant 6 (not shown). Additional or different components may be included in completed sub-assembly 16. In certain embodiments completed sub-assemblies 16 may be located within completed glazing unit 15 and may be distributed along all four sides (e.g. edges) of glazing unit 15 (not shown). For example, in certain embodiments completed glazing unit 15 may include one completed sub-assembly 16 per side, one spacer 1 per side, and a plurality of flexible-mounting-components 2 (not shown). In certain embodiments, a plurality of flexible-mounting-components 2 may be distributed along all four sides of glazing unit 15.

In certain embodiments, desiccant material may be included within a fully assembled glazing unit, and may be replaceable. In one embodiment two layers of film may be suspended from one film-support-frame, such as, for example, film-support frame or spacer, utilizing a plurality of flexible-mounting-components that oppose each other. In certain embodiments, the space between films can be sized to optimize thermal properties. In certain embodiments, the film-support-frames may be assembled independent of the glass sheets, which may optimize the overall manufacturing process, although it is conceivable that the film-support-frames and glass sheets may also be assemble concurrently (e.g. at the same time). In certain embodiments of the present invention, multiple film-support-frames or spacers may be utilized thereby creating multiple spaces in the glazing unit. The design according to this embodiment may increase the thermal efficiency of insulated glass unit.

In certain embodiments, significant bottlenecks in the processing may be reduced by eliminating glass sheets from the process of film suspension. A manufacturing process according to embodiments of the present invention may also limit the capital expenditures for glass processing equipment thereby decreasing the overall cost of the process.

A manufacturing process according to embodiments of the present invention may also be helpful in limiting the occurrence of manufacturing defects. Certain embodiments may limit the inventory requirements when compared to what would be required if the glass were to be processed at the same facility and time.

Various embodiments are described herein, with various features. In some embodiments, certain features may be omitted, or features from one embodiment may be used with another embodiment. Modifications of embodiments of the present invention will occur to persons skilled in the art. All such modifications are within the scope and spirit of the present invention as defined by the appended claims.

What is claimed is:

1. A glazing unit comprising:
a spacer;
a first plurality of flexible-mounting-components extending from the spacer in a first direction, each of the first plurality of flexible-mounting-components attached to the spacer at a first end of the flexible-mounting component;
a second plurality of flexible-mounting-components extending from the spacer in a second direction, each of the second plurality of flexible-mounting-components attached to the spacer at a first end of the flexible-mounting component;
a first flexible film attached to a second end of each of the first plurality of flexible-mounting components; and
a second flexible film attached to a second end of each of the second plurality of flexible-mounting components;
wherein the first film and the second film are substantially parallel to each other.

2. The glazing unit of claim 1, comprising two glass sheets mounted to the spacer creating a space enclosing the first and second flexible films.

3. The glazing unit of claim 1, comprising:
a plurality of spacers, each having a plurality of flexible mounting components extending therefrom, each of the flexible mounting components attached to one of the first flexible film and the second flexible film; and
a plurality of glass sheets mounted to the spacers creating a space enclosing the first and second flexible films.

4. The glazing unit of claim 1, wherein the first direction and the second direction are generally opposite to one another.

5. The glazing unit of claim 1, wherein each of the plurality of flexible-mounting-components extends in a direction towards the attachment point of one of the other plurality of flexible-mounting-components.

6. The glazing unit of claim 1, wherein each of the first plurality of flexible-mounting-components extends in an opposing direction away from the direction in which the second plurality of flexible-mounting-components extends.

7. The glazing unit of claim 4, wherein the distance between the first flexible film and the second flexible film is substantially the length of the flexible-mounting-components.

8. A glazing unit comprising:
a substructure;
at least one support frame attached to the substructure, each support frame having a plurality of grooves;
a first set of stretchable mounting units each having an attachment end attached to one of the plurality of grooves at the attachment end and extending from a groove in a first direction;
a second set of stretchable mounting units each having an attachment end attached to one of the plurality of grooves at the attachment end and extending from the groove in a second direction;
a first flexible sheet attached to the first set of stretchable mounting units opposite the attachment end of each of the first set stretchable mounting units;
a second flexible sheet attached to the second set of stretchable mounting units opposite the attachment end of each of the second set stretchable mounting units;
wherein the first sheet and second sheet are substantially parallel to each other.

9. The glazing unit of claim 8, comprising two glass sheets mounted to the substructure creating a space enclosing the first and second flexible sheets.

10. The glazing unit of claim 8, wherein the first direction and second direction are generally opposite to one another.

11. The glazing unit of claim 8, wherein the first direction extends towards the attachment end of the second set of stretchable mounting units, and the second direction extends towards the attachment end of the first set of stretchable mounting units.

12. The glazing unit of claim 8, wherein the first direction extends in an opposing direction away from the attachment end of the second set of stretchable mounting units, and the second direction extends in an opposing direction away from the attachment end of the first set of stretchable mounting units.

13. The glazing unit of claim 11, wherein the distance between the first flexible sheet and the second flexible sheet is substantially the length of the stretchable mounting units.

14. The glazing unit of claim 8, comprising:
a plurality of substructures, each substructure having a support frame attached to the substructure, each support frame having a plurality of grooves and a plurality of stretchable mounting units attached to one of the plurality of grooves; and
two glass sheets mounted to the substructure creating a space enclosing the first and second flexible sheets.

15. A method of manufacturing a glazing unit, the method comprising:
in a first phase:
attaching to a spacer a first plurality of flexible-mounting-components extending from the spacer in a first direction, each of the first plurality of flexible-mounting-components attached to the spacer at a first end of the flexible-mounting component;
attaching to the spacer a second plurality of flexible-mounting-components extending from the spacer in a second direction, each of the second plurality of flexible-mounting-components attached to the spacer at a first end of the flexible-mounting component;
attaching a first flexible film to a second end of each of the first plurality of flexible-mounting components; and
attaching a second flexible film to a second end of each of the second plurality of flexible-mounting components; and
in a second phase, attaching two glass sheets to the spacer to create a space enclosing the first and second flexible sheets.

16. The method of claim 15, wherein attaching the flexible-mounting-components results in an alternating arrangement of the first and second plurality of flexible-mounting-components such that adjacent flexible-mounting-components extend in generally opposite directions.

17. The method of claim 15, wherein the first and second plurality of flexible-mounting-components are attached such that the first and second directions are generally opposite to one another.

18. The method of claim 15, wherein the flexible-mounting-components are attached such that each of the plurality of flexible-mounting-components extends in a direction towards the attachment point of one of the other plurality of flexible-mounting-components.

19. The method of claim 15, wherein the flexible-mounting-components are attached such that each of the plurality of flexible-mounting-components extends in an opposing direction away from the attachment point of one of the other plurality of flexible-mounting-components.

20. The method of claim 15, comprising attaching a layer of stainless steel is applied to the spacer.
